(19) United States
(12) Patent Application Publication
(10) Pub. No.: US 2005/0063192 A1
(43) Pub. Date: Mar. 24, 2005

(54) Vehicular headlamp

(75) Inventors: Naoki Tatara, Shizuoka-shi (JP); Masahito Naganawa, Shizuoka-shi (JP)

Correspondence Address: KODA & ANDROLIA, 2029 CENTURY PARK EAST, SUITE 1430, LOS ANGELES, CA, 90067-3024, US

(73) Assignee: Koito Manufacturing Co., Ltd.

(21) Appl. No.: 10/941,721

(22) Filed: Sep. 15, 2004

(30) Foreign Application Priority Data
Sep. 19, 2003 (JP) 2003-328145

(51) Int. Cl. F21V 17/02

(52) U.S. Cl. 362/512

(57) ABSTRACT

A vehicular headlamp including a movable main shade and an auxiliary shade that is provided on the movable shade. The movable shade is movable from a light shielding position for forming a low-beam distribution pattern to a light shielding reduction position for forming a high-beam distribution pattern; and by this movement of the movable shade, the auxiliary shade is moved from its light shielding position, at which the auxiliary shade shields reflected light from a lower reflection area of the reflector, to a light shielding release position, at which the auxiliary shade is released from shielding the reflected light.

### BACKGROUND OF THE INVENTION

1. Field of the Invention

The present invention relates to a so-called projector-type vehicular headlamp and more particularly to a vehicular headlamp that has a movable shade therein.

2. Prior Art

Generally, in a projector-type vehicular headlamp, a projection lens is provided on an optical axis extending in the longitudinal direction of a vehicle (or the headlamp), and a light source is provided behind the rear side focal point of the projection lens so that light from the light source is reflected towards the optical axis by a reflector.

When a low-beam distribution pattern is formed by the projector-type vehicular headlamp, part of light reflected by the reflector is shielded by a shade that is provided so that the upper edge of the shade is positioned near the optical axis in the vicinity of the rear side focal point of the projection lens, so that a predetermined cut-off line is formed in an upper portion of the low-beam distribution pattern.

Japanese Patent Application Laid-Open (Kokai) No. 2001-110213 discloses a projector-type vehicular headlamp that has, as the above-described shade, a movable shade. This movable shade is moved to a light shielding reduction position so that the shade reduces the amount of shielding with respect to the light reflected by the reflector.

The vehicular headlamp of the above prior art is capable of forming a high-beam distribution pattern by way of moving the movable shade to the light shielding reduction position. Therefore, a single lamp can be used for both low-beam and high-beam.

However, the vehicular headlamp of the above-described prior art has several problems. Since the low-beam distribution pattern and the high beam distribution pattern are formed by reflected light from the same reflection area of the reflector, if the reflector has a reflective surface with a shape suitable for the low-beam distribution pattern, a light distribution pattern suitable for the high-beam distribution pattern cannot always be obtained. On the other hand, if the reflector has a reflective surface with a shape suitable for the high-beam distribution pattern, then a light distribution pattern suitable for the low-beam distribution pattern cannot always be obtained.

### SUMMARY OF THE INVENTION

It is, therefore, an object of the present invention to provide a projector-type vehicular headlamp that has a movable shade being capable of making proper low-beam distribution pattern and high-beam distribution pattern.

The present invention accomplishes the object by way of providing an auxiliary shade that is movable in accordance with the movement of a movable (main) shade.

The above object is accomplished by a unique structure of the present invention for a vehicular headlamp that includes a projection lens provided on an optical axis that extends in the longitudinal direction of the headlamp, a light source provided behind the rear side focal point of the projection lens, a reflector that reflects light from the light source in the forward direction toward the optical axis, and a shade that shields part of the reflected light from the reflector; and the shade is movable between light shielding position, at which the upper edge of the shade is positioned near the optical axis in the vicinity of the rear side focal point, and a light shielding reduction position, at which the amount of shielding of the reflected light from the reflector is reduced compared to that at the light shielding position; and in the present invention, the vehicular headlamp further includes an auxiliary shade that shields reflected light from the lower reflection area of the reflector, and the auxiliary shade is configured so as to move, in accordance with the movement of the movable (main) shade from the light shielding position to the light shielding reduction position, from a light shielding position, at which the reflected light from the lower reflection area is shielded, to a light shielding release position, at which the shielding is released so that no shielding of light by the auxiliary shade occurs.

Types of the above-described light source are not particularly limited; and, for example, a discharging light source of a discharging bulb, a filament of a halogen bulb, and the like can be the light source in the present invention.

Furthermore, the above-described “lower reflection area” of the reflector refers to an area in the reflective surface of the reflector, and the lower reflection area is positioned generally lower than the optical axis.

A specific configuration such as a shape and a location of the auxiliary shade is not particularly limited as long as it can shield the reflected light from the lower reflection area of the reflector. Further, the auxiliary shade is moved integrally with the movable shade, and it can be moved independently of the movable shade as long as the auxiliary shade is moved in accordance with movement of the movable shade.

As seen from the above, the vehicular headlamp of the present invention is provided with a movable shade that is capable of moving between the light shielding position and the light shielding reduction position. In addition to this, the vehicular headlamp is provided with an auxiliary shade that shields reflected light from the lower reflection area of the reflector. In accordance with movement of the movable shade from the light shielding position to the light shielding reduction position, the auxiliary shade is moved from the light shielding position, at which the reflected light from the lower reflection area is shielded, to the light shielding release position, at which the shielding is released and no shielding of light by the auxiliary shade occurs. Thus the vehicular headlamp of the present invention has several advantages as described below.

When the movable shade is at the light shielding position, a low-beam distribution pattern that has, at an upper end portion thereof, cut-off lines as an inverted projection image of an upper edge thereof is formed. When the movable shade is thus at the light shielding position, however, the auxiliary shade is also located at the light shielding position; accordingly, light reflected from the lower reflection area of the reflector is shielded by the auxiliary shade, and the low-beam distribution pattern is formed only by the reflected light from the upper reflection area of the reflector.

On the other hand, when the movable shade is at the light shielding reduction position, a high-beam distribution pattern that extends up to above the cut-off lines of the low-beam distribution pattern is formed. When the movable shade is at the light shielding reduction position, however, the auxiliary shade is located at the light-shielding release position; accordingly, not only the reflected light from the upper reflection area of the reflector but also the light reflected from the lower reflection area thereof are utilized for light distribution pattern.

Since the reflected light from the lower reflection area forms the high-beam distribution pattern, the lower reflection area can be designed without taking any effect on the low-beam distribution pattern into consideration and can be designed with only the formation of the high-beam distribution pattern taken into consideration.

Accordingly, first, the upper reflection area of the reflector is formed so as to have a reflective surface with a shape that is capable of obtaining an appropriate low-beam distribution pattern; and the reflective surface of the lower reflection area of the reflector is shaped so that an additional distribution pattern, which compensates a portion that is lacking as the high-beam distribution pattern when such a setting is made, is additionally formed by reflected light from the lower reflection area of the reflector. With this structure, the low-beam distribution pattern becomes an appropriate distribution pattern, and in addition, the high-beam distribution pattern also becomes an appropriate distribution pattern.

Thus, according to projector-type vehicular headlamp of the present invention that has a movable shade, both the low-beam distribution pattern and the high-beam distribution pattern become appropriated distribution patterns.

In the present invention, a specific shape of the lower reflection area of the reflector is not particularly limited. However, by way of setting the lower reflection area to have a reflective surface with a shape that has higher performance in condensing light towards the vicinity of the rear side focal point compared to the upper reflection area of the reflector, a central light intensity of the high-beam distribution pattern increases significantly. Therefore, visibility for a road surface that is far away in front of the vehicle is enhanced.

Moreover, in the present invention, the auxiliary shade is provide on the movable shade; and in this structure, the auxiliary shade is moved together with the movable shade. Accordingly, the auxiliary shade can move without a need of an additional actuator therefor. The auxiliary shade can be formed independently of the movable shade and is fixed thereto with a screw and the like. Alternatively, the auxiliary shade can be integrally configured with the movable shade.

### BRIEF DESCRIPTION OF THE DRAWINGS

FIG. 1 is a side cross sectional view of a vehicular headlamp according to one embodiment of the present invention;

FIG. 2 is a side cross sectional view of a lamp unit of the vehicular headlamp, illustrating a light path when the movable shade is located at a light shielding position;

FIG. 3 is a side cross sectional view of the lamp unit of the vehicular headlamp, illustrating a light path when the movable shade is located at a light shielding reduction position;

FIG. 4 is a perspective view showing the main portion of the lamp unit;

FIGS. 5(a) and 5(b) respectively show the low-beam and high-beam distribution patterns that are formed by light emitted forward from the vehicular headlamp on a virtual vertical screen located about 25 meters ahead of the lamp; and

FIGS. 6(a) through 6(c) show the high-beam distribution pattern divided into the three components, i.e., the low-beam distribution pattern (FIG. 6(c)), a first additional distribution pattern (FIG. 6(b)), and a second additional distribution pattern (FIG. 6(a)).

### DETAILED DESCRIPTION OF THE INVENTION

Hereinafter, embodiments of the present invention will be described below with reference to the accompanying drawings.

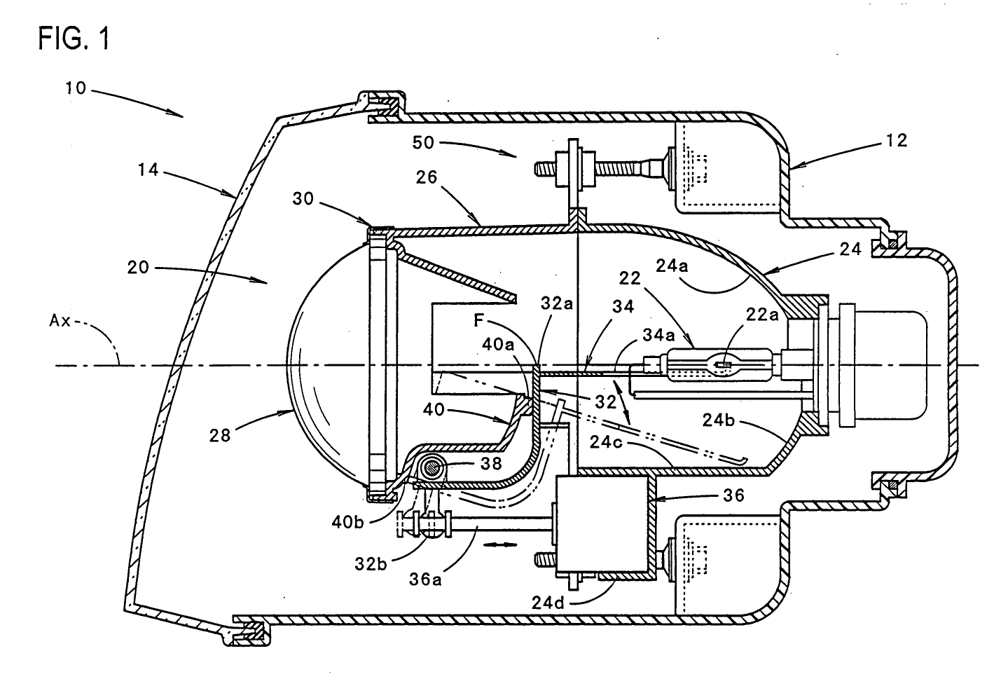

FIG. 1 shows in cross section a vehicular headlamp according to one embodiment of the present invention viewed from the side.

As seen from FIG. 1, the vehicular headlamp 10 includes a lamp unit 20 which is housed in a lamp chamber formed by a lamp body 12 and a generally plain translucent cover 14 attached to the front edge opening portion of the lamp body 12. The lamp unit 20 has an optical axis Ax that extends in the longitudinal direction of a vehicle (on which the lamp 10 is mounted) or of the headlamp 10, and it is movable in a tilt manner in the vertical direction and in the lateral direction via an aiming mechanism 50.

When the aiming adjustment executed by the aiming mechanism 50 is completed, the optical axis Ax of the lamp unit 20 extends in a direction downward by approximately 0.5 ° to 0.6° with respect to the longitudinal direction of the vehicle.

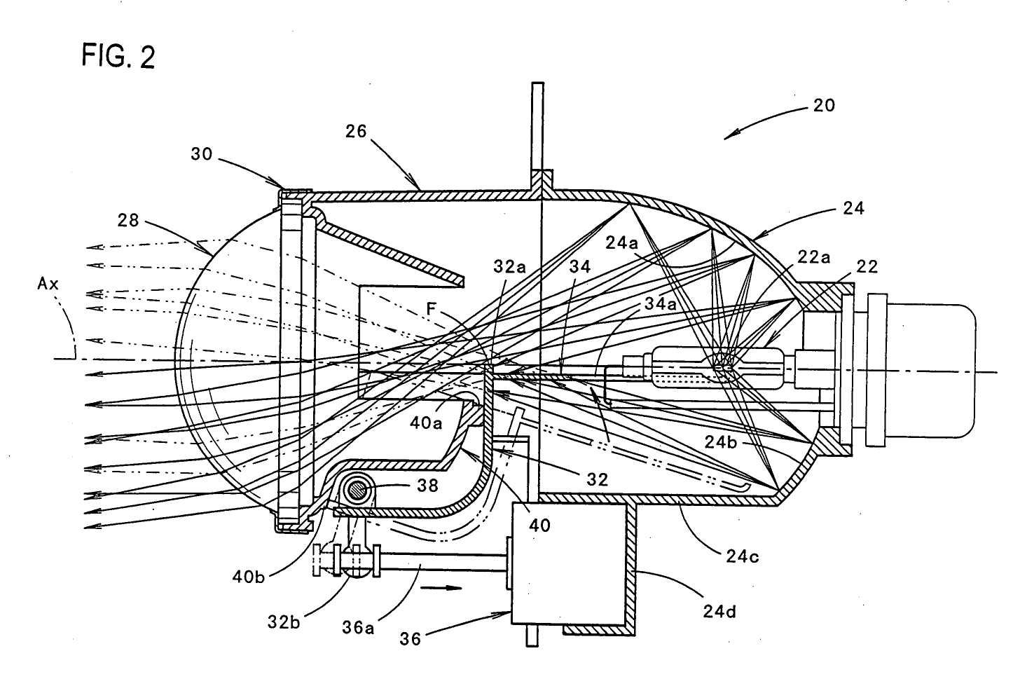

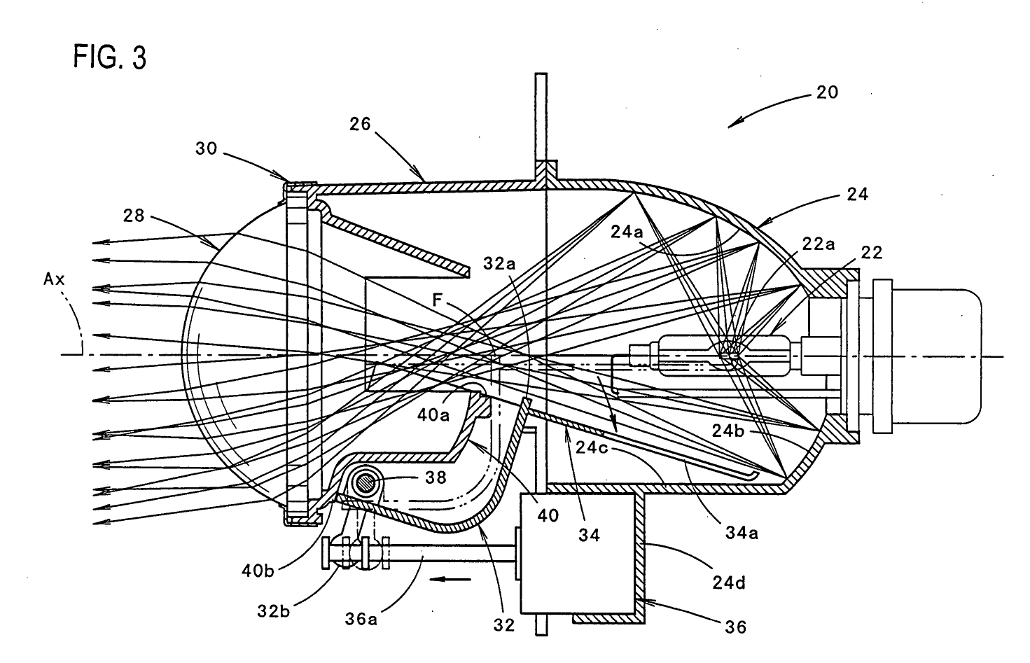

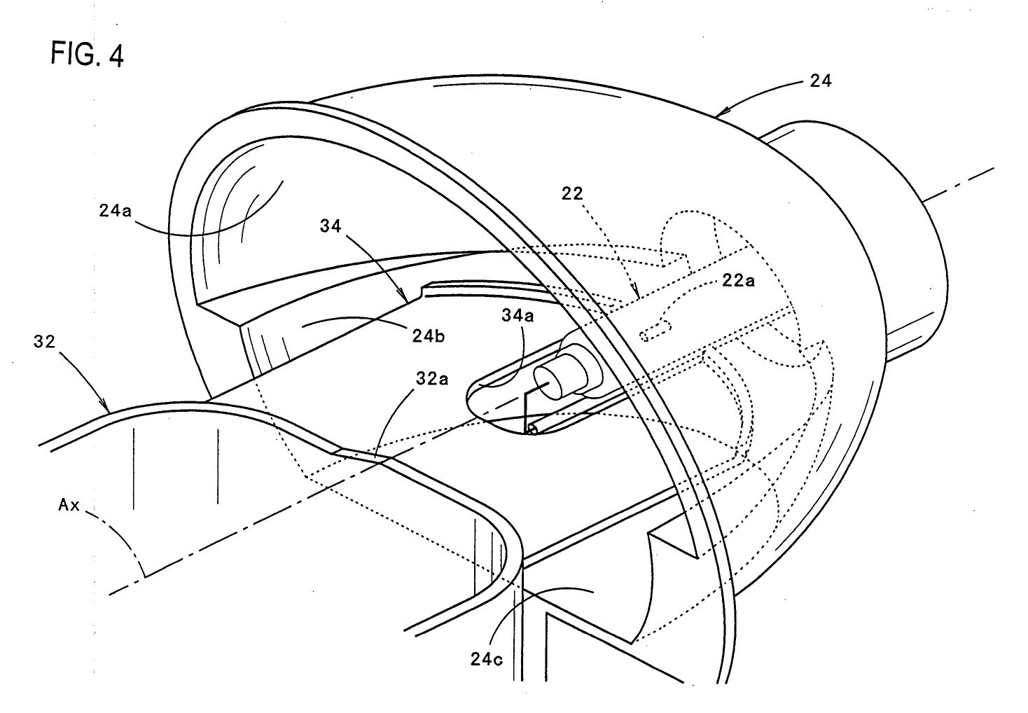

FIGS. 2 and 3 show in cross section the lamp unit 20. FIG. 4 is a perspective view of the main portion of the lamp unit 20.

As seen from FIGS. 2 through 4, the lamp unit 20 is a projector-type lamp unit and is provided with a light source bulb 22, a reflector 24, a holder 26, a projection lens 28, a retaining ring 30, a movable shade 32, an auxiliary shade 34, and a shade actuator 36.

The projector lens 28 is a plane-convex lens with its front side surface convex and its rear side surface flat. The projector lens 28 is disposed on the optical axis Ax and projects forward an image on a focal surface, which includes a rear side focal point F, as an inverted image.

The light source bulb 22 is a discharge bulb such as a metal halide bulb or the like, using a discharging light source as its light source 22a. The light source bulb 22 is attached to the reflector 24 such that its light source 22a is coaxial with the optical axis Ax behind the rear side focal point F of the projection lens 28.

The reflector 24 reflects light from the light source 22a forward (toward the left side in, for instance, FIG. 2) so as to direct the light towards the optical axis Ax. The reflector 24 is comprised of an upper reflection area 24a located on its upper side and a lower reflection area 24b located on its lower side with respect to a horizontal plane that includes the optical axis Ax and serves as a boundary. The upper and lower reflection areas 24a and 24b differ from each other in shape.

More specifically, in the upper reflection area 24a, its cross section including the optical axis Ax is in a generally elliptical shape, and its eccentricity becomes gradually larger from the vertical cross section towards the horizontal cross section. With structure, in the vertical cross section, light from the light source 22a that is reflected by the upper reflection area 24a is substantially converged to a position which is slightly forward of the rear focal point F, while in the horizontal cross section, the convergence position shifts substantially forward.

On the other hand, in the lower reflection area 24b, its cross section including the optical axis Ax is in a generally elliptical shape, and its eccentricity is set so as to be a substantially fixed value from the vertical cross section to the horizontal cross section. With this structure, light from the light source 22a that is reflected by the lower reflection area 24b is substantially converged to a position which is slightly forward of the rear focal point F in each cross section so as to condense more light towards the vicinity of the rear side focal point F compared to the upper reflection area 24a.

A bottom wall 24c is formed at the lower end portion of the reflector 24, so that the reflection area of the lower reflection area 24b is smaller than that of the upper reflection area 24a.

The holder 26 is formed in generally a cylindrical shape that extends forward from the front end opening portion of the reflector 24. The holder 26 secures and holds the reflector 24 at its rear end portion and secures and holds the projection lens 28 through the retaining ring 30 at its front end portion.

The movable shade 32 is provided in generally a lower half portion of the space inside the holder 26, and it is held rotatably by the holder 26 by a rotating pin 38 that extends in the lateral direction of the holder 26. As seen from FIG. 1, the movable shade 32 is positioned at a light shielding position that is shown by the solid line and is positioned also at a light shielding reduction position that is a position where the movable shade 32 is rotated downward by a predetermined angle from the light shielding position as shown by two dotted line.

In front of the movable shade 32, a fixed shade 40 for inhibiting stray light reflected by the reflector 24 from entering the projection lens 28 is integrally formed on the holder 26. The fixed shade 40 has an upper abutting portion 40a and a lower abutting portion 40b. The upper abutting portion 40a abuts the movable shade 32 so as to position the movable shade 32 to the light shielding position when the movable shade 32 is moved to the light shielding position. The lower abutting portion 40b abuts the movable shade 32 so as to position the movable shade 32 to the light shielding reduction position when the movable shade 32 is moved to the light shielding reduction position.

FIG. 2 shows the light path when the movable shade 32 is at the light shielding position, and FIG. 3 shows the light path when the movable shade 32 is at the light shielding reduction position.

As seen from FIG. 2, when the movable shade 32 is located at the light shielding position, the upper edge 32a of the movable shade 32 passes through the rear side focal point F of the projection lens 28, thus shielding part of reflected light from the upper reflection area 24a and lower reflection area 24b of the reflector 24 and removing most of the upward directed light that is emitted forward from the projection lens 28. On the other hand, as seen from FIG. 3, when the movable shade 32 is moved from the light shielding position to the light shielding reduction position, the upper edge 32a of the movable shade 32 is displaced obliquely downward so as to reduce the amount of shielding of light reflected by the upper reflection area 24a and lower reflection area 24b of the reflector 24. In the shown embodiment, the amount of shielding of reflected light from the upper reflection area 24a and lower reflection area 24b of the reflector 24 is set to be substantially zero, so that light reflected by the upper reflection area 24a and lower reflection area 24b of the reflector 24 is substantially not shielded when the movable shade 32 is at the light shielding reduction position.

The auxiliary shade 34 is integrally formed on the movable (main) shade 32; and it is as shown in FIG. 4 is generally a tabular member that protrudes rearward from a portion near the upper edge of the rear surface of the movable shade 32.

When the movable shade 32 is at the light shielding position as shown in FIG. 2, the auxiliary shade 34 on the movable (main) shade 32 is almost under the optical axis Ax and generally extends horizontally, thus taking a position (the light shielding position) so that it shields reflected light from the lower reflection area 24b of the reflector 24. When the movable shade 32 is moved from the light shielding position to the light shielding reduction position as shown in FIG. 3, the auxiliary shade 34 on the movable shade 32 is displaced downward and is brought under the optical axis Ax to extend obliquely backward, so that the movable shade 32 is positioned (at the light shielding release position) to release the shielding of reflected light from the lower reflection area 24b of the reflector 24, allowing the reflected light to pass through the projection lens 28.

When the auxiliary shade 34 is at the light shielding position, its rear edge is near the light source 22a as shown by dotted lines in FIGS. 1 and 2. When the auxiliary shade 34 is at the light shielding release position, the rear edge is positioned near above the portion in the vicinity of the rear end of the bottom wall 24c as best seen from FIG. 3 and shown by solid lines. As seen from FIG. 4, the auxiliary shade 34 is formed, at its lateral center, with a generally U-shaped notch 34a that extends forward from the rear edge. With this notch 34a, when the auxiliary shade 34 is at the light shielding position, the light source bulb 22 is inside the notch 34a and thus interference between the auxiliary shade 34 and the light source bulb 22 is prevented, and reflected light from the lower reflection area 24b of the reflector 24 is still substantially completely shielded.

The shade actuator 36, which activates the movable shade 32 and thus also the auxiliary shade 34, is comprised of, for instance, a solenoid, and it has an output shaft 36a extending in the longitudinal direction. The shade actuator 36 is provided on an attachment portion 24d formed on the lower surface of the bottom wall 24c of the reflector 24. The output shaft 36a of the shade actuator 36 is coupled, at a front end thereof, to a stay 32b that extends downward from the movable shade 32. The output shaft 36a thus transfers reciprocating motion of the output shaft 36a in the longitudinal direction to the movable shade 32 so that the movable shade 32 is rotated about the rotating pin 38. The shade actuator 36 is actuated to move the output shaft 36a in the longitudinal direction when a beam selecting switch, not shown, is operated; and as a result of the actuated shade actuator 36, the movable shade 32 is moved or pivoted between the light shielding position and the light shielding reduction position; and in accordance with this movement of the movable shade 32, the auxiliary shade 34, which is on the movable shade 32, is moved between the light shielding position and the light shielding release position.

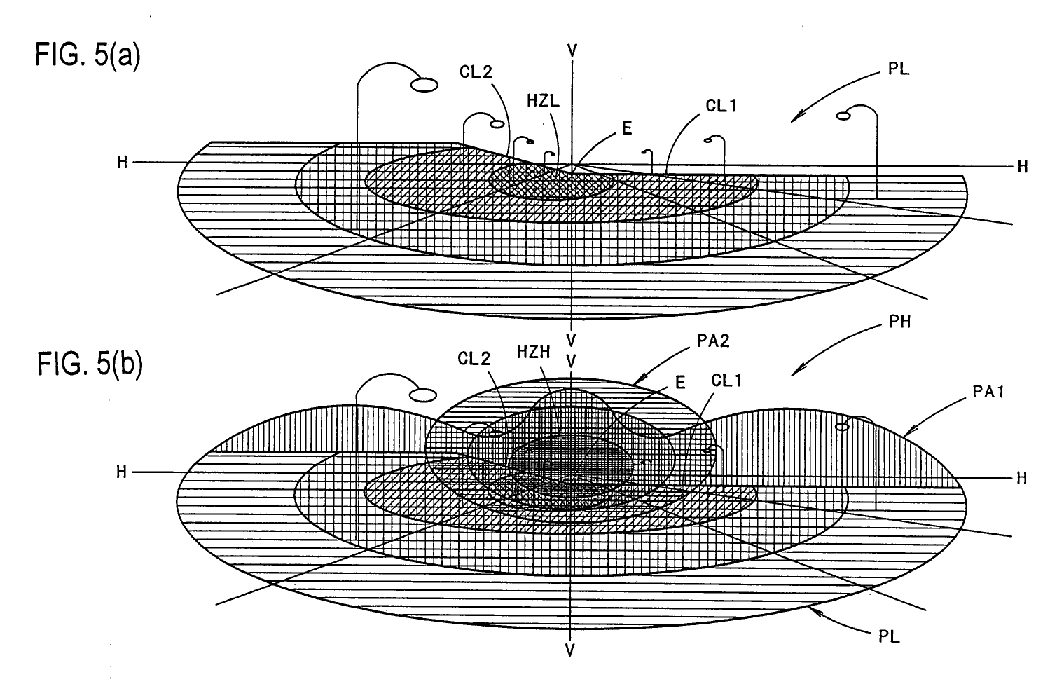

FIGS. 5(a) and 5(b) illustrate light distribution patterns that are formed by light emitted forward from the vehicular headlamp 10 on a virtual vertical screen located about 25 meters ahead of the lamp, FIG. 5(a) showing the low-beam distribution pattern, and FIG. 5(b) showing the high-beam distribution pattern.

The low-beam distribution pattern PL shown in FIG. 5(a) is a low-beam distribution pattern for the left side of the street. The low-beam distribution pattern PL has, at an upper edge thereof, a horizontal cut-off line CL1, and an oblique cut-off line CL2 that is at a predetermined angle (for example, approximately 15 degrees) with respect to the horizontal cut-off line CL1. An elbow point E that is an intersection of the cut-off lines CL1 and CL2 is set at a position lower by approximately 0.5 to 0.6 degrees than H-V that is a vanishing point in front of the lamp. In this low-beam distribution pattern PL, a hot zone HZL where light intensity is high is somewhat offset leftward from the elbow point E and surrounds this elbow point E.

In the shown low-beam distribution pattern PL, a plurality of curved lines that are concentrically formed with curved lines indicative of outlines thereof are iso-illuminance curves. It is indicated that the low-beam distribution pattern PL gradually becomes brighter from its outer peripheral edge towards the hot zone HZL.

The low beam distribution pattern PL is formed when the movable shade 32 is at the light shielding position, and the horizontal and oblique cut-off lines CL1 and CL2 of the low beam distribution pattern PL are formed as inverted projection images of the upper edge 32a of the movable shade 32. When the movable shade 32 is thus at the light shielding position, since the auxiliary shade 34 is located at its own light shielding position, reflected light from the lower reflection area 24b of the reflector 24 is shielded by the auxiliary shade 34, so that the low-beam distribution pattern PL is formed only by reflected light from the upper reflection area 24a of the reflector 24.

On the other hand, the high-beam distribution pattern PH shown in FIG. 5(b) is formed as a combined distribution pattern of the low-beam distribution pattern PL, a first additional distribution pattern PA1 that extends upward from the horizontal and oblique cut-off lines CL1 and CL 2 of the low-beam distribution pattern PL, and a second additional distribution pattern PA2. The high-beam distribution pattern PH has a hot zone HZH in the vicinity of H-V.

The high-beam distribution pattern PH in FIG. 5(b) is formed when the movable shade 32 is at the light shielding reduction position, the first additional distribution pattern PA1 is formed by reflected light from the upper reflection area 24a of the reflector 24, and more specifically, it is formed by reflected light that increases when the movable shade 32 is moved from the light shielding position to-the light shielding reduction position; and further the second additional distribution pattern PA2 is formed by reflected light from the lower reflection area 24b of the reflector 24 when shielding is released when the auxiliary shade 34 is moved from the light shielding position to the light shielding release position.

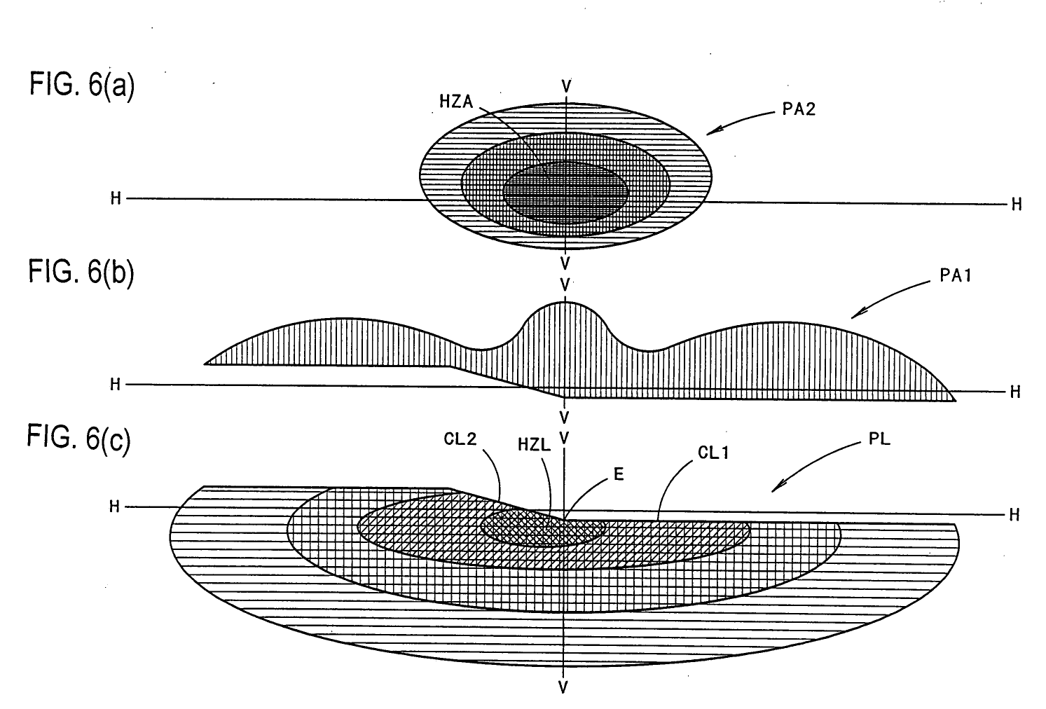

FIGS. 6(a) through 6(c) illustrate the high-beam distribution pattern PH divided into its components, i.e., the low-beam distribution pattern, the first additional distribution pattern PA1, and the second additional distribution pattern PA2.

As shown in FIG. 6(b), the first additional distribution pattern PA1 takes, in the area above the horizontal and oblique cut-off lines CL1 and CL2 of the low-beam distribution pattern PL, an irregular-shaped distribution pattern that has unevenness. This is because the shape of the upper reflection area 24a of the reflector 24 is set with priority being given so that it obtains the low-beam distribution pattern PL shown in FIG. 6(c), and thus the first additional distribution pattern PA1 is caused to take an irregular shape with uneven light distribution.

As shown in FIG. 6(a), the second additional distribution pattern PA2 is a relatively small distribution pattern, where iso-illuminance curves extend slightly upward, having its center in the vicinity of H-V. The central light intensity of the hot zone HZA is set so as to be a substantially high value. The second additional distribution pattern is superposed on the first additional distribution pattern PA1, thus reducing unevenness in light distribution. Moreover, by superposing these first and second additional distribution patterns PA1 and PA2 on the low-beam distribution pattern PL as shown in FIG. 5(b), the high-beam distribution pattern PH, which is a combined distribution pattern, has the hot zone HZH in the vicinity of H-V, and the unevenness in light distribution is significantly reduced.

As seen from the above, the vehicular headlamp 10 of the present invention includes the movable shade 32 that is capable of moving between the light shielding position and the light shielding reduction position, and this movable shade 32 is provided with the auxiliary shade 34 that shields reflected light from the lower reflection area 24b of the reflector 24. When the movable shade 32 moves from the light shielding position to the light shielding reduction position, the auxiliary shade 34 is moved from its light shielding position, where the auxiliary shade 34 shields reflected light from the lower reflection area 24b, to the light shielding release position, where the shielding by the auxiliary shade 34 is released. Accordingly, the vehicular headlamp of the present invention has the advantages as described below.

When the movable shade 32 is located at the light shielding position, a low-beam distribution pattern PL that has, at its upper end portion, horizontal and oblique cut-off lines CL1 and CL2 as an inverted projection image of the upper edge 32a is formed. When the movable shade 32 is thus located at the light shielding position, the auxiliary shade 34 is located at its own light shielding position. Therefore, reflected light from the lower reflection area 24b of the reflector 24 is shielded by the auxiliary shade 34, so that the low-beam distribution pattern PL is formed only by reflected light from the upper reflection area 24a of the reflector 24.

On the other hand, when the movable shade 34 is located at the light shielding reduction position, the high-beam distribution pattern PH is formed so that it extends up to above the horizontal and oblique cut-off lines CL1 and CL2. When the movable shade 34 is thus located at the light shielding reduction position, the auxiliary shade 34 is located at the light-shielding release position. Therefore, not only reflected light from the upper reflection area 24a of the reflector 24, but also reflected light from the lower reflection area 24b is utilized to form the light distribution pattern.

In this case, the reflected light from the lower reflection area 24b is used only for forming the high-beam distribution pattern PH. Accordingly, the lower reflection area 24b of the reflector 24 can be designed so as to have a shape of reflective surface with only the formation of high-beam distribution pattern PH taking into consideration and without taking any on the low-beam distribution pattern PL into consideration.

Accordingly, as seen from the described embodiment, first, the upper reflection area 24a of the reflector 24 is designed to have a reflective surface with a shape that is capable of obtaining an appropriate low-beam distribution pattern PL; then the reflector shape of the lower reflection area 24b of the reflector 24 is set so that the second additional distribution pattern PA2, which compensates a portion that is lacking as the high-beam distribution pattern PH when such a setting is made, is additionally formed by reflected light from the lower reflection area 24b of the reflector 24. By doing this, the low-beam distribution pattern PL becomes an appropriate distribution pattern, and further the high-beam distribution pattern PH also becomes an appropriate distribution pattern.

In the shown embodiment, the lower reflection area 24b of the reflector 24 has a reflective surface with a shape that has higher performance in condensing light towards the vicinity of the rear side focal point F of the projection lens 28 compared to the upper reflection area 24a of the reflector 24. Therefore, the second additional distribution pattern PA2 can be formed as a distribution pattern that has a high central light intensity. As a result, the central light intensity of the high-beam distribution pattern PH sufficiently increases, and visibility for the road surface which is far away in front of the vehicle can be enhanced. Moreover, the unevenness in light distribution of the first additional distribution pattern PA1 that is made by reflected right from the upper reflection area 24a of the reflector 24, more specifically, made by reflected light that is increased in accordance with movement of the movable shade 32 from the light shielding position to the light shielding reduction position can be absorbed by superposing the second additional distribution pattern PA2.

In the shown embodiment, the auxiliary shade 34 has the integrally formed movable shade 32. Accordingly, the auxiliary shade 34 is integrally moved with the movable shade 32, and this movement of the auxiliary shade 34 is made without a need for an additional actuator for the shade actuator (solenoid) 36.

1. A vehicular headlamp comprising:
a projection lens provided on an optical axis extending in a longitudinal direction of the headlamp,
a light source provided behind a rear side focal point of the projection lens,
a reflector that reflects light from the light source in a forward direction toward the optical axis, and
a shade that shields part of reflected light from the reflector;
wherein the shade is a movable shade that is movable between a light shielding position at which an upper edge of the shade is positioned near the optical axis in the vicinity of the rear side focal point and a light shielding reduction position at which an amount of shielding of the reflected light from the reflector is reduced compared to that at the light shielding position; and
wherein the vehicular headlamp is further comprised of an auxiliary shade capable of shielding reflected light from a lower reflection area of the reflector; and in accordance with a movement of the movable shade from the light shielding position to the light shielding reduction position, the auxiliary shade is moved from a light shielding position at which reflected light from the lower reflection area is shielded to a light shielding release position at which a shielding is released.

2. The vehicular headlamp according to claim 1, wherein the lower reflection area of the reflector is set so as to have a reflective surface with a shape that has high performance in condensing light towards the vicinity of the rear side focal point compared to an upper reflection area of the reflector.

3. The vehicular headlamp according to claim 1, wherein the auxiliary shade is integrally formed with the movable shade.

4. The vehicular headlamp according to claim 2, wherein the auxiliary shade is integrally formed with the movable shade.
